(19) United States
(12) Patent Application Publication
(10) Pub. No.: US 2007/0289179 A1
(43) Pub. Date: Dec. 20, 2007

(54) Device for displaying a disabled parking permit

(76) Inventor: Michael Mortensen, Highland Beach, FL (US)

Correspondence Address: ROBERT M. DOWNEY, P.A., 6751 N. FEDERAL HWY., SUITE 300, BOCA RATON, FL, 33487, US

(21) Appl. No.: 11/440,285

(22) Filed: May 24, 2006

(51) Int. Cl. G09F 11/18; G09F 7/22

(52) U.S. Cl. 40/514; 40/617

(57) ABSTRACT

A device for displaying a disabled parking permit includes a housing with a hook for hanging the device from a rear view mirror in a motor vehicle. The disabled parking permit is provided on opposite faces of a flexible sheet placard that is wound onto a spring-loaded roll contained within the housing. The placard can be pulled down from a slot opening on the bottom of the housing to a fully extended position for displaying the disabled parking permit in a manner that allows visibility from both the front and rear of the vehicle when the vehicle is parked. The placard retracts and rolls up within the housing, onto the spring-loaded roll, to avoid obstruction of view when driving.

### BACKGROUND OF THE INVENTION

1. Field of the Invention

The present invention relates to disabled parking permits, and, more particularly, to a device for displaying a disabled parking permit on a retractable placard, and wherein the device allows the placard to be extended in order to fully display the disabled parking permit when parked, and, further, wherein the device allows the placard to retract to avoid obstruction of view.

2. Discussion of the Related Art

State motor vehicle laws provide for disabled parking permits that allow persons with either long-term or temporary mobility impairment to park in designated handicap parking spaces at public parking facilities. To qualify for a disabled parking permit, a person must be certified by a licensed physician or other qualified medical professional as having a disability that renders the person physically impaired. The disabled parking permit is provided on a placard that is placed in the disabled person's vehicle so that the placard is visible from the front and rear of the vehicle when parked in a designated disabled parking space. In most cases, the placard is hung from the support arm of the vehicle's rear view mirror. Each side of the placard must have the international symbol of handicap accessibility (i.e. stick figure illustration of a person seated in a wheel chair) in a contrasting color in the center of the placard. The placard must display the disabled person's permit number.

The placard is normally provided with a cut-out portion on the top that forms a hook for hanging the placard on the support arm of the rear view mirror. This allows the disabled parking permit to be displayed in the manner required by law when parked in a designated disabled parking space. When driving, the placard is not needed and, when left hanging from the rear view mirror, has been determined to present an obstruction to the driver's view. To avoid obstruction of view, and possible fine by law enforcement, the driver is instructed to remove the placard from the rear view mirror when driving. However, when parking in a designated disabled parking space, the driver often forgets to replace the placard on the rear view mirror so that the parking permit is displayed in the lawful manner. If the disabled parking permit is not displayed, by hanging the placard on the rear view mirror, the driver will be issued a citation requiring payment of a fine. To avoid payment of the fine, the driver must appear in court and present evidence of having the required disabled parking permit.

The presently used placard for displaying a disabled parking permit is inconvenient and continually exposes the driver to a potential citation and fine for either obstruction of view or failure to display the required disabled parking permit. Accordingly, there remains an urgent need for a convenient and effective device that allows a driver of a motor vehicle to properly display the disabled parking permit when parked in a designated disabled parking space and to neatly retract the placard containing the disabled parking permit while driving to avoid obstruction of view.

### OBJECTS AND ADVANTAGES OF THE INVENTION

Considering the foregoing, it is a primary object of the present invention to provide a device for displaying a disabled parking permit on a retractable placard, and wherein the device allows the placard to be extended in order to fully display the disabled parking permit when parked in a designated handicap parking space and, further, wherein the device allows the placard to retract into a housing in order to avoid obstruction of view when driving the vehicle.

It is a further object of the present invention to provide a device for displaying a disabled parking permit, and wherein the device includes a spring-loaded roll contained within a housing for allowing a placard displaying the disabled parking permit to be extended for viewing when parked and rolled up, in a manner similar to a roll-up window shade, when driving the vehicle.

It is still a further object of the present invention to provide a device for conveniently displaying a disabled parking permit on a placard which is retractable from view when driving and, wherein the device is simple to use and easily installed in any vehicle by hanging the device on the support arm of the rear view mirror.

It is still a further object of the present invention to provide a device for displaying a disabled parking permit, as described above, and wherein the housing of the device provides for display of the owner's disabled parking permit number and the international handicap symbol when the placard is retracted within the housing, thereby avoiding a possible fine in the event the driver forgets to extend the placard when parking.

These and other objects and advantages of the invention are more readily apparent with reference to the detailed description and drawings.

### SUMMARY OF THE INVENTION

The present invention is directed to a device for displaying a disabled parking permit in a motor vehicle when parked in a designated handicap parking space. The device includes a housing with a hook for hanging the device from a rear view mirror in a motor vehicle. The disabled parking permit is provided on opposite faces of a flexible sheet placard that is wound onto a spring-loaded roll contained within the housing. The placard can be pulled down from a slot opening on the bottom of the housing to a fully extended position for displaying the disabled parking permit in a manner that allows visibility from both the front and rear of the vehicle when the vehicle is parked. The placard retracts and rolls up within the housing, onto the spring-loaded roll, to avoid obstruction of view when driving.

### BRIEF DESCRIPTION OF THE DRAWINGS

For a fuller understanding of the nature of the present invention, reference should be made to the following detailed description taken in conjunction with the accompanying drawings in which:

FIG. 1 is a front perspective view of the disabled parking permit display device of the present invention shown with the placard in a fully extended position to display the disabled parking permit;

FIG. 2 is a perspective view of the device with the placard in a retracted position;

FIG. 3 is side elevational view, in partial cross-section, showing the placard wound onto a spring-loaded roll within the housing device when in the retracted position;

FIG. 4 is a front plan view, taken from an exterior of a vehicle and looking through the front windshield, showing the device hanging from a rear view mirror with the placard in the extended position to display the disabled parking permit; and

FIG. 5 is a plan view looking forward from within the vehicle and showing the device hanging from the rear view mirror with the placard in the extended position to display the disabled parking permit.

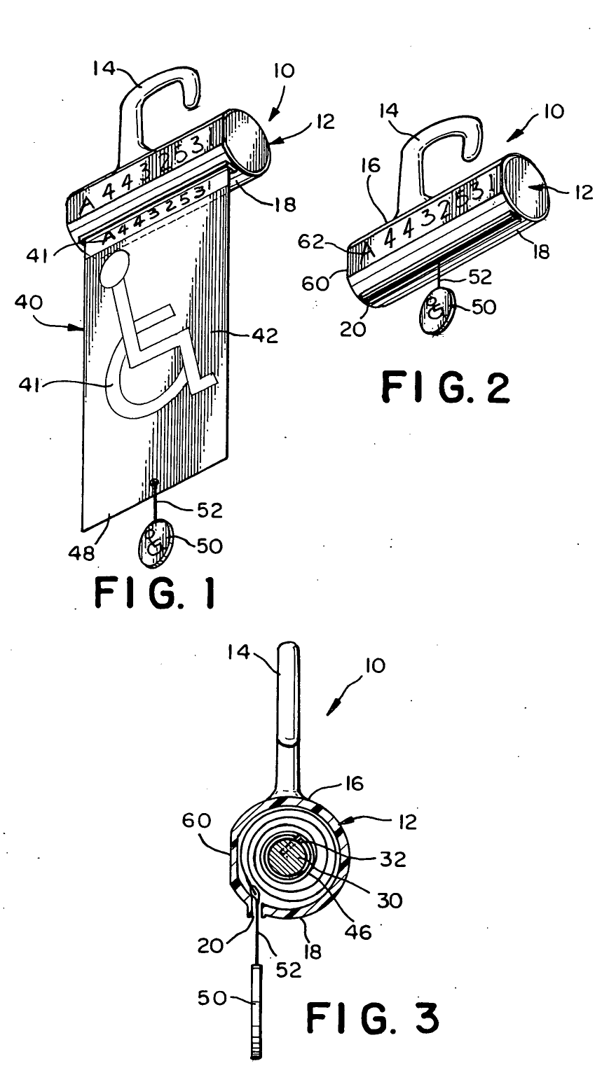

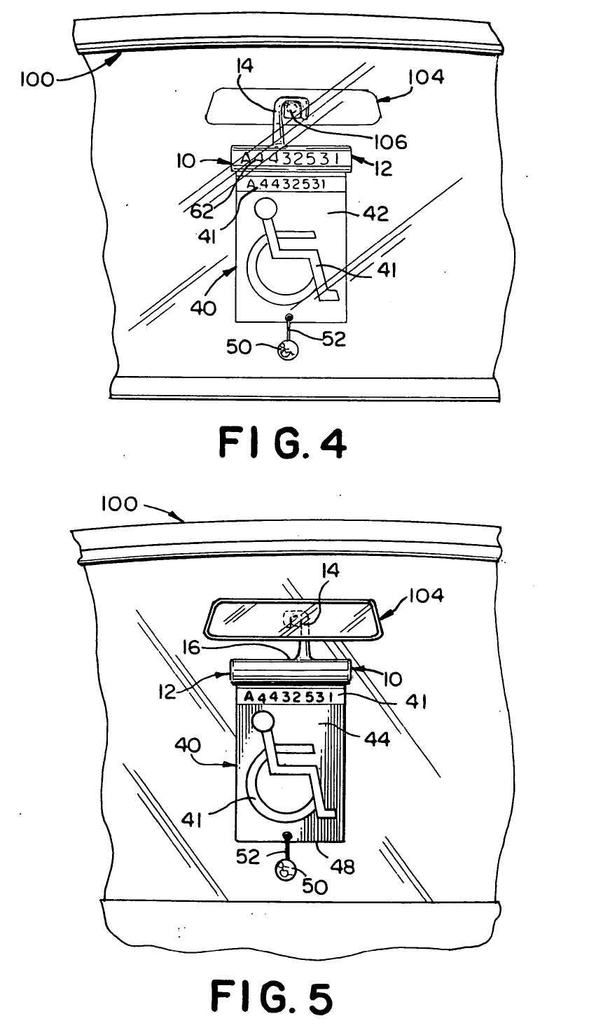

Like reference numerals refer to like parts throughout the several views of the drawings.

### DETAILED DESCRIPTION OF THE PREFERRED EMBODIMENT

As shown throughout the several views of the drawings, the present invention is directed to a device for displaying a disabled parking permit in a motor vehicle when parked in a designated handicap parking space. The device, generally indicated as 10, includes a housing 12 that is formed of a rigid material, such as molded plastic, with a hook 14 extending from the top 16 for hanging the device 10 on the support arm 106 of a rear view mirror 104 in the vehicle 100. The housing 12 includes a slot opening 20 along the bottom 18 communicating with an interior chamber 22. A spring-loaded roll 30 is rotatably supported with the interior chamber 22. The roll 30 operates in a manner similar to a roll-up window shade.

A placard 40 is provided on a flexible sheet substrate and contains the disabled parking permit which is displayed by indicia 41 on both sides 42, 44 of the placard. A top end 46 of the placard 40 is attached to the spring-loaded roll 30 and, when in a retracted position, the placard 40 is wound about the roll 30 within the housing 12. A pull tab 50 with a connecting cord 52 extends from a bottom edge 48 of the placard and remains accessible on an exterior of the housing, hanging down from the slot opening 20. By pulling downwardly on a tab 50, the placard 40 is unrolled and extended from the slot opening 20 until reaching a fully extended position that visibly exposes the disabled parking permit on both the front and rear faces 42,44 of the placard. When reaching the fully extended position, the downward pull on the tab 50 is released and the spring-loaded roll 30 locks against the potential energy of the spring 32.

In the fully extended position, the disabled parking permit is visible from the front and rear of the vehicle, as required by law. By applying a short downward tug on the pull tab 50, the spring-loaded roll 30 is released from the locked position, allowing the stored energy of the spring within the roll to rotate the roll 30 in a wind-up action, similar to a roll-up window shade. This causes the placard 40 to be wound onto the roll 30 within the housing 12, thereby effectively retracting the placard 40 from view. The placard 40 retracts and rolls-up within the housing 12, onto the spring-loaded roll 30, to avoid obstruction of view when driving.

In a preferred embodiment, the housing 12 and hook 14 are integrally molded as one piece and a designated area 60 is formed on the housing exterior (e.g. a flat surface) for attaching a decal 62 that contains the user's disabled parking permit number.

While the instant invention has been shown and described in accordance with a preferred and practical embodiment thereof, it is recognized that departures from the instant disclosure are contemplated within the spirit and scope of the present invention.

1: A device for displaying a disabled parking permit within a vehicle having a rear view mirror held on a support arm, said device comprising;
a housing including an upwardly extending finger formed in an inverted J-shape to define a hook for supported engagement over the support arm in order to hang the device from the support arm of the rear view mirror, and said housing having an interior chamber and a slot opening communicating with said interior chamber;
a spring-loaded roll rotatably supported within said interior chamber of said housing and said spring-loaded roll being rotatably operable from a relaxed state against a spring-biased force to a selected locked position;
a flexible sheet substrate defining a placard and including a front face, a rear face, a top end and a bottom end, and indicia on both said front face and said rear face, and said indicia representing the disabled parking permit;
said top end of said placard being attached to said spring-loaded roll and said placard being wound about said spring-loaded roll so that said placard is contained within said interior chamber of said housing and concealed within said housing when said spring-loaded roll is in said relaxed state, and said placard being extendable out through said slot opening and against said spring-biased force to a fully extended position at said selected locked position of said spring-loaded roll to visibly expose said front and rear faces of said placard and said disabled parking permit provided by said indicia; and
said spring-loaded roll being selectively operable from said locked position to said relaxed position to cause said placard to be retracted through said slot opening and into said interior chamber and wound about said spring-loaded roll, thereby concealing said placard, including the disabled parking permit, from view.

2: The device as recited in claim 1 wherein said housing includes a flat surface portion on an exterior defining a designated area for attachment of a decal containing indicia corresponding to said indicia on said placard.

3: The device as recited in claim 1 further comprising:
a pull tab with a connecting cord extending from said bottom end of said placard to enable operation of said spring-loaded roll and movement of said placard between said relaxed state with said placard retracted within said housing, and said selected locked position with said placard at said fully extended position, by pulling downwardly on said pull tab.

4: A device for displaying a disabled parking permit within a vehicle having a rear view mirror held on a support arm, said device comprising;
a housing including an upwardly extending finger formed in an inverted J-shape to define a hook for supported engagement over the support arm in order to hang the device from the support arm of the rear view mirror, and said housing having an interior chamber and a slot opening communicating with said interior chamber;
a spring-loaded roll rotatably supported within said interior chamber of said housing and said spring-loaded roll being rotatably operable from a relaxed state against a spring-biased force to a selected locked position;
a flexible sheet substrate defining a placard and including a front face, a rear face, a top end and a bottom end, and indicia on both said front face and said rear face, and said indicia representing the disabled parking permit;
said top end of said placard being attached to said spring-loaded roll and said placard being wound about said spring-loaded roll so that said placard is contained within said interior chamber of said housing and concealed within said housing when said spring-loaded roll is in said relaxed state, and said placard being extendable out through said slot opening and against said spring-biased force to a fully extended position at said selected locked position of said spring-loaded roll to visibly expose said front and rear faces of said placard and said disabled parking permit provided by said indicia;
said spring-loaded roll being selectively operable from said locked position to said relaxed position to cause said placard to be retracted through said slot opening and into said interior chamber and wound about said spring-loaded roll, thereby concealing said placard, including the disabled parking permit, from view; and
said housing including a flat exterior surface portion defining a designated area for attachment of a decal thereto, and said decal having indicia corresponding to said indicia on said placard.
